(19) United States
(12) Patent Application Publication
(10) Pub. No.: US 2022/0065707 A1
(43) Pub. Date: Mar. 3, 2022

(54) TEMPERATURE SENSOR ELEMENT

(71) Applicant: SUMITOMO CHEMICAL COMPANY, LIMITED, Tokyo (JP)

(72) Inventors: Megumi HAYASAKA, Osaka-shi (JP); Yuichiro KUNAI, Toyonaka-shi (JP)

(73) Assignee: SUMITOMO CHEMICAL COMPANY, LIMITED, Tokyo (JP)

(21) Appl. No.: 17/419,562

(22) PCT Filed: Mar. 4, 2020
(86) PCT No.: PCT/JP2020/009081

§ 371 Date: Jun. 29, 2021

(30) Foreign Application Priority Data
Mar. 29, 2019 (JP) 2019-068126

(51) Int. Cl. G01K 7/22; G01N 23/20; C08L 79/08; H01C 7/04; H01C 1/14

(52) U.S. Cl. CPC G01K 7/22; G01N 23/20; C08L 79/08; C08L 2203/20; H01C 1/1413; G01N 2223/056; C08L 2203/16; H01C 7/049

(57) ABSTRACT

There is provided a temperature sensor element including a pair of electrodes and a temperature-sensitive film disposed in contact with the pair of electrodes, in which the temperature-sensitive film includes a matrix resin and a plurality of conductive domains contained in the matrix resin, and the matrix resin constituting the temperature-sensitive film has a degree of molecular packing of 40% or more, as determined based on measurement by an X-ray diffraction method, according to expression (i): Degree of molecular packing (%)=100×(Area of peak derived from ordered structure)/(Total area of all peaks).

### TECHNICAL FIELD

The present invention relates to a temperature sensor element.

### BACKGROUND ART

There has been conventionally known a thermistor-type temperature sensor element including a temperature-sensitive film changed in electric resistance value due to the change in temperature. An inorganic semiconductor thermistor has been conventionally used in the temperature-sensitive film of such a thermistor-type temperature sensor element. Such an inorganic semiconductor thermistor is hard, and thus a temperature sensor element using the same is usually difficult to have flexibility.

Japanese Patent Laid-Open No. H3-255923 (Patent Literature 1) relates to a thermistor-type infrared detection element using a polymer semiconductor having NTC characteristics (Negative Temperature Coefficient; characteristics of the reduction is electric resistance value due to the rise in temperature). The infrared detection. element detects infrared light by detecting the rise in temperature due to incident infrared light, in terms of the change in electric resistance value, and includes a pair of electrodes and a thin film including the polymer semiconductor containing an electronically conjugated organic polymer partially doped, as a component.

### CITATION LIST

### Patent Literature

Patent Literature 1: Japanese Patent Laid-Open No. H3-255923

### SUMMARY OF INVENTION

### Technical Problem

The thin film in the infrared detection element disclosed in Patent Literature 1 is formed by an organic substance, and thus flexibility can be imparted to the infrared detection element.

However, Patent Literature 1 does not consider any suppression of the variation in instruction value (stability of electric resistance value) of the infrared detection element which is placed under a certain temperature environment. The instruction value is also referred to as “electric resistance value”.

An object of the present invention is to provide a thermistor-type temperature sensor element including a temperature-sensitive film including an organic substance, in which the temperature sensor element can exhibit a stable electric resistance value under a certain temperature environment for a long time.

### Solution to Problem

The present invention provides the following temperature sensor element.

[1] A temperature sensor element including a pair of electrodes and a temperature-sensitive film disposed in contact with the pair of electrodes, wherein

the temperature-sensitive film includes a matrix resin and a plurality of conductive domains contained in the matrix resin, and

the matrix resin constituting the temperature-sensitive film has a degree of molecular packing of 40% or more, as determined based on measurement by an X-ray diffraction method, according to the following expression (I):

Degree of molecular packing (%)=100×(Area of peak derived from ordered structure)/(Total area of all peaks) (I).

[2] The temperature sensor element according to [1], wherein the conductive domains include a conductive polymer.

[3] A temperature sensor element including a pair of electrodes and a temperature-sensitive film disposed in contact with the pair of electrodes, wherein

the temperature-sensitive film is formed from a polymer composition including a matrix resin having a degree of molecular packing of 40% or more, as determined based on measurement by an X-ray diffraction method, according to the following expression (I), and a conductive particle:

Degree of molecular packing (%)=100×(Area of peak derived from ordered structure)/(Total area of all peaks) (I).

[4] The temperature sensor element according to [3], wherein the conductive particle includes a conductive polymer.

[5] The temperature sensor element according to any of [1] to [4], wherein the matrix resin includes a polyimide-based resin.

[6] The temperature sensor element according to [5], wherein the polyimide based resin. includes an aromatic ring.

### Advantageous Effect of Invention

There can be provided a temperature sensor element that can exhibit a stable electric resistance value under a certain temperature environment for a long time.

### BRIEF DESCRIPTION OF DRAWINGS

FIG. 1 is a schematic top view illustrating one example of the temperature sensor element according to the present invention.

FIG. 2 is a schematic cross-sectional view illustrating one example of the temperature sensor element according to the present invention.

FIG. 3 is a schematic top view illustrating a method of producing a temperature sensor element of Example 1.

FIG. 4 is a schematic top view illustrating the method of producing the temperature sensor element of Example 1.

FIG. 5 is a SEM photograph of a temperature-sensitive film included in the temperature sensor element of Example 1.

### DESCRIPTION OF EMBODIMENTS

The temperature sensor element according to the present invention (hereinafter, also simply referred to as “temperature sensor element”.) includes a pair of electrodes and a temperature-sensitive film disposed in contact with the pair of electrodes.

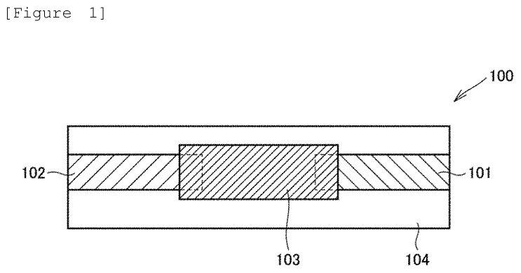

FIG. 1 is a schematic top view illustrating one example of the temperature sensor element. A temperature sensor element 100 illustrated in FIG. 1 includes a pair of electrodes of a first electrode 101 and a second electrode 102, and a temperature-sensitive film 103 disposed in contact with both the first electrode 101 and the second electrode 102. The temperature-sensitive film 103, both ends of which are formed on the first electrode 101 and the second electrode 102, respectively, is thus in contact with such electrodes.

The temperature sensor element can further include a substrate 104 that supports the first electrode 101, the second electrode 102 and the temperature-sensitive film 103 (see FIG. 1).

The temperature sensor element 100 illustrated in FIG. 1 is a thermistor-type temperature sensor element where the temperature-sensitive film 103 detects the change in temperature, as an electric resistance value.

The temperature-sensitive film 103 may have NTC characteristics that exhibit a decrease in electric resistance value due to the rise in temperature.

[1] First Electrode and Second Electrode

The first electrode 101 and the second electrode 102 here used are sufficiently small in electric resistance value as compared with the temperature-sensitive film 103. The respective electric resistance values of the electrode 101 and the second electrode 102 included in the temperature sensor element are specifically preferably 500Ω or less, more preferably 200Ω or less, further preferably 100Ω or less at a temperature of 25° C.

The respective materials of the first electrode 101 and the second electrode 102 are not particularly limited as long as a sufficiently small electric resistance value is obtained as compared with that of the temperature-sensitive film 103, and such each material can be, for example, a metal single substance such as gold, silver, copper, platinum, or palladium; an alloy including two or more metal materials; a metal oxide such as indium tin oxide (ITO) or indium zinc oxide (IZO); or a conductive organic substance (for example, a conductive polymer).

The material of the first electrode 101 and the material of the second electrode 102 may be the same as or different from each other.

The respective methods of forming the first electrode 101 and the second electrode 102 are not particularly limited, and may be each a common method such as vapor deposition, sputtering, or coating (coating method). The first electrode 101 and the second electrode 102 can be each formed directly on the substrate 104.

The respective thicknesses of the first electrode 101 and the second electrode 102 are not particularly limited as long as a sufficiently small electric resistance value is obtained as compared with that of the temperature-sensitive film 103, and such each thickness is, for example, 50 nm or more and 1000 nm or less, preferably 100 nm or more and 500 nm or less.

[2] Substrate

The substrate 104 is a support that supports the first electrode 101, the second electrode 102 and the temperature-sensitive film 103.

The material of the substrate 104 is not particularly limited as long as the material is non-conductive (insulating), and the material may be, for example, a resin material such as a thermoplastic resin or an inorganic material such as glass. In a case where a resin material is used in the substrate 104, the temperature-sensitive film 103 has flexibility and thus flexibility can be imparted to the temperature sensor element.

The thickness of the substrate 104 is preferably set in consideration of flexibility, durability, and the like or the temperature sensor element. The thickness of the substrate 104 is, for example, 10 μm or more and 5000 μm or less, preferably 50 μm or more and 1000 μm or less.

[3] Temperature-Sensitive Film

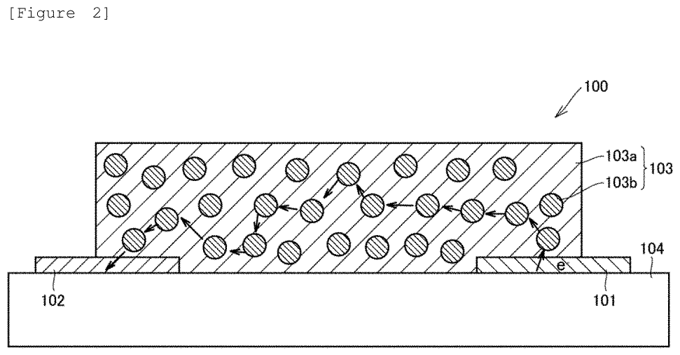

FIG. 2 is a schematic cross-sectional view illustrating one example of the temperature sensor element. A temperature-sensitive film 103 includes a matrix resin 103a and a plurality of conductive domains 103b contained in the matrix resin 103a in the temperature sensor element according to the present invention, as in a temperature sensor element 100 illustrated in FIG. 2. The plurality of conductive domains 103b are preferably dispersed in the matrix resin 103a.

The conductive domains 103b refer to a plurality of regions in the temperature-sensitive film 103 included in the temperature sensor element, which are contained in the matrix resin 103a and which contribute to electron transfer.

The conductive domains 103b can include, for example, a conductive component such as a conductive polymer, a metal, a metal oxide, or graphite, and is preferably constituted by a conductive component such as a conductive polymer, a metal, metal oxide, or graphite. The conductive domains 103b can include one or more conductive components.

Examples of the metal include gold, copper, silver, nickel, zinc, aluminum, tin, indium, barium, strontium, magnesium, beryllium, titanium, zirconium, manganese, tantalum, bismuth, antimony, palladium, and an alloy of two or more selected from these metals.

Examples of the metal oxide include indium tin oxide (ITO), indium zinc oxide (IZO), zinc lithium oxide-manganese composite oxide, vanadium pentoxide, tin oxide, and potassium titanate.

In particular, the conductive domains 103b have an advantage in enhancing the temperature dependence of the electric resistance value exhibited by the temperature-sensitive film 103, and thus preferably include a conductive polymer and are more preferably constituted by a conductive polymer.

[3-1] Conductive Polymer

The conductive polymer included in the conductive domains 103b includes a conjugated polymer and a dopant, and is preferably a conjugated polymer doped with a dopant.

A conjugated polymer by itself is usually extremely low in electric conductivity, and exhibits almost no electric conducting properties, for example, which correspond to 1×10⁻⁶ S/m or less. The reason why a conjugated polymer by itself is low in electric conductivity is because the valance band is saturated with electrons and such electrons cannot be freely transferred. On the other hand, a conjugated polymer, in which electrons are delocalized, is thus remarkably low in ionization potential and very large in electron affinity as compared with a saturated polymer. Accordingly, a conjugated polymer easily allows charge transfer with an appropriate dopant such as an electron acceptor (acceptor) or an electron donor (donor) to occur, and such a dopant can withdraw an electron from the valance band of such a conjugated polymer or inject an electron to the conduction band thereof. Thus, such a conjugated polymer doped with a dopant, namely, the conductive polymer can have a few holes present in the valance band or a few electrons present in the conduction band to allow such holes and/or electrons to be freely transferred, and thus tends to be drastically enhanced in conductive properties.

The conductive polymer, which is a single substance, preferably has a value of linear resistance R in the range of 0.01Ω or more and 300 MΩ or less at a temperature of 25° C., as measured with an electric tester at a distance between lead bars of several mm to several cm.

The conjugated polymer constituting the conductive polymer is one having a conjugated structure in its molecule, and examples include a polymer having a backbone where a double bond and a single bond are alternately linked, and a polymer having an unshared pair of electrons conjugated.

Such a conjugated polymer can easily impart electric conducting properties by doping, as described above.

The conjugated polymer is not particularly limited, and examples thereof include polyacetylenes poly(p-phenylenevinylene); polypyrrole; polythiophene-based polymers such as poly(3,4-ethylenedioxythiophene) [PEDOT]; and polyaniline-based polymers (for example, polyaniline, and polyaniline having a substituent). The polythiophene-based polymer here means, for example, polythiophene, a polymer having a polythiophene backbone and having a side chain into which a substituent is introduced, and a polythiophene derivative. The “-based polymer” mentioned herein means a similar molecule.

The conjugated polymer may be used singly or in combinations of two or more kinds thereof.

The conjugated polymer is preferably a polyaniline-based polymer from the viewpoint of easiness of polymerization and identification.

Examples of the dopant include a compound serving as an electron acceptor (acceptor) from the conjugated polymer and a compound serving as an electron donor (donor) to the conjugated polymer.

The dopant serving as an electron acceptor is not particularly limited, and examples thereof include halogen such as Cl₂, Br₂, I₂, ICl, ICl₃, IBr, and IF₃; Lewis acids such as PF₅, AsF₅, SbF₅, BF₃, and SO₃; proton acids such as HCl, H₂SO₄, and HClO₄; transition metal halides such as FeCl₃, FeBr₃, and SnCl₄; and organic compounds such as tetracyanoethylene (TCNE), tetracyanoquinodimethane (TCNQ), 2,3-dichloro-5,6-dicyano-p-benzoquinone (DDQ), amino acids, polystyrenesulfonic acid, p-toluenesulfonic acid, and camphorsulfonic acid.

The dopant serving as an electron donor is not particularly limited, and examples thereof include alkali metals such as Li, Na, K, Rb, and Cs; alkali earth metals such as Be, Mg, Ca, Sc, Ba, Ag, Eu, and Yb, or other metals.

The dopant is preferably selected appropriately depending on the type of the conjugated polymer.

The dopant may be used singly or in combinations of two or more kinds thereof.

The content of the dopant in the temperature-sensitive film 103 is preferably 0.1 mol or more, more preferably 0.4 mol or more based on 1 mol of the conjugated polymer, from the viewpoint of conductive properties of the conductive polymer. The content is preferably 3 mol or less, more preferably 2 mol or less based on 1 mol of the conjugated polymer.

The content of the dopant in the temperature-sensitive film 103 is preferably 1% by mass or more, more preferably 3% by mass or more based on the mass of the temperature-sensitive film of 100% by mass, from the viewpoint of conductive properties of the conductive polymer. The content is preferably 60% by mass or less, more preferably 50% by mass or less relative to the temperature-sensitive film.

The electric conductivity of the conductive polymer is obtained by combining the electronic conductivity in a molecular chain, the electronic conductivity between molecular chains, and the electronic conductivity between fibrils.

Carrier transfer is generally described by a hopping conduction mechanism. An electron present at a localized level in a non-crystalline region can be jumped to an adjacent localized level by the tunneling effect, in a case where the distance between localized states is short. In a case where there is a difference in energy between localized states, a thermal excitation process depending on the difference in energy is required. The conduction due to tunneling with such a thermal excitation process corresponds to hopping conduction.

In a case where the density of states is high at a low temperature or in the vicinity of the Fermi level, hopping to a distal level, small in difference in energy, is more dominant than hopping to a proximal level, large in difference in energy. In such a case, a variable range hopping conduction model (Mott-VRH model) is applied.

As can be understood from a variable range hopping conduction model (Mott-VRH model), the conductive polymer has NTC characteristics that exhibit a decrease in electric resistance value due to the rise in temperature.

[3-2] Matrix Resin

The matrix resin 103a included in the temperature-sensitive film 103 is a matrix that fixes the plurality of conductive domains 103b into the temperature-sensitive film 103.

The plurality of conductive domains 103b including the conductive polymer can be contained in, preferably dispersed in the matrix resin 103a, thereby allowing the distance between the conductive domains to be increased to some extent. Thus, the electric resistance detected by the temperature sensor element can be any electric resistance mainly derived from hopping conduction (electron transfer indicated by an arrow in FIG. 2) between the conductive domains. Such hopping conduction is highly dependent on the temperature, as can be understood from a variable range hopping conduction model (Mott-VRH model). Accordingly, such hopping conduction can be dominant to result in an enhancement in temperature dependence of the electric resistance value exhibited by the temperature-sensitive film 103.

The plurality of conductive domains 103b including the conductive polymer can be contained in, preferably dispersed in the matrix resin 103a, thereby providing a temperature sensor element that can exhibit a stable electric resistance value under a certain temperature environment for a long time.

The plurality of conductive domains 103b including the conductive polymer are contained in, preferably dispersed in the matrix resin 103a, resulting in a tendency to obtain a temperature sensor element that hardly causes defects such as cracks to occur in the temperature-sensitive film 103 in use of the temperature sensor element and that has such a temperature-sensitive film 103 excellent in stability over time.

Examples of the matrix resin 103a include a cured product or an active energy ray-curable resin, a cured product of a thermosetting resin, and a thermoplastic resin. In particular, a thermoplastic resin is preferably used.

The thermoplastic resin is not particularly limited, and examples thereof include polyolefin-based resins such as polyethylene and polypropylene; polyester-based resins such as polyethylene terephthalate; polycarbonate-based resins; (meth)acrylic resins; cellulose-based resins; polystyrene-based resins; polyvinyl chloride-based resins; acrylonitrile-butadiene-styrene-based resins; acrylonitrile-styrene-based resins; polyvinyl acetate-based resins; polyvinylidene chloride-based resins; polyamide-based resins; polyacetal-based resins; modified polyphenylene ether-based resins; polysulfone-based resins; polyethersulfone-based resins; polyarylate-based resins; and polyimide-based resins such as polyimide and polyamideimide.

The matrix resin 103a may be used singly or in combinations of two or more kinds thereof.

In the present invention, the matrix resin 103a constituting the temperature-sensitive film 103 has a decree of molecular packing of 40% or more, as determined based on measurement by an X-ray diffraction method, according to the following express ion (I). The temperature-sensitive film 103 is preferably formed from a polymer composition (polymer composition for a temperature-sensitive film) including such a matrix resin having a degree of molecular packing of 40% or more, as determined based on measurement by an X-ray diffraction method, according to the following expression (I). Thus, a temperature sensor element can be provided which can detect a less varied and stable electric resistance value under a certain temperature environment for a long time.

Degree of molecular packing (%)=100×(Area of peak derived from ordered structure)/(Total area of all peaks) (I)

The degree of molecular packing in the matrix resin 103a is preferably 50% or more, more preferably 60% or more, further preferably 65% or more, from the viewpoint of an enhancement in stability of the electric resistance value under a certain temperature environment. The degree of molecular packing in the matrix resin 103a is preferably 50% or more in order that the temperature sensor element, even when placed under a high humidity and certain temperature environment, can detect a stable electric resistance value for a long time. The degree of molecular packing in the matrix resin 103a is more preferably 55% or more, further preferably 60% or more, still further preferably 65% or more.

The degree of molecular packing is usually 90% or less, more preferably 85% or less.

A peak derived from an ordered structure in the expression (i) refers to a peak having a half-value width of 10° or less. Such a peak having a half-value width of 10° or less can be said to be a peak derived from an ordered structure. Examples of such a peak having a half-value width of 10° or less include a peak derived from an ordered arrangement of a polymer chain due to π-π stacking interaction and a peak derived from an ordered arrangement of a polymer chain with a hydrogen bond. All peaks mean a peak derived from an ordered structure and a peak derived from an amorphous structure. Such a peak derived from an amorphous structure refers to a peak having a half-value width of more than 10°. Such a peak having a half-value width of more than 10° can be said to be a peak derived from a random structure, namely, an amorphous structure.

The area of a peak derived from an ordered structure in the expression (i) refers to the area of a peak derived from an ordered structure, as defined above, determined by performing fitting of an X-ray profile obtained by measurement by an X-ray diffraction method, with the Gaussian function, and peak separation. Such an X-ray profile here corresponds to a graph of 2θ versus intensity, and such fitting with the Gaussian function corresponds to the Gaussian distribution approximation. The area of a peak derived from an ordered structure refers to the total area when two or more of such peaks are present.

The total area of all peaks in the expression (i) refers to the total area of all peaks, as defined above, determined by performing fitting of an X-ray profile obtained by measurement by an X-ray diffraction method, with the Gaussian function, and peak separation. Such an X-ray profile here corresponds to a graph of 2θ versus intensity, and such fitting with the Gaussian function corresponds to the Gaussian distribution approximation.

The XRD measurement apparatus for use in an X-ray diffraction method can be a usual XRD apparatus.

The degree of molecular packing in the matrix resin 103a constituting the temperature-sensitive film 103 can be measured by adopting a film formed from the matrix resin, as described below, as a measurement sample, and subjecting the film to an X-ray diffraction method. For example, measurement can be made according to the following method. First, a solvent corresponding to a solvent that dissolves the matrix resin 103a and that is a poor solvent to the conductive polymer is added to the temperature-sensitive film 103, and the resultant is centrifuged. A supernatant is taken out, the supernatant is used to produce a film on a glass substrate according to a spin coating or casting method, and the film is dried in an oven at 100° C. for 2 hours to produce a film M1 of the matrix resin. Next, the film M1 is subjected to measurement by an X-ray diffraction method.

On the other hand, the degree of molecular packing in the matrix resin included in the polymer composition for a temperature-sensitive film can be measured by adopting a film formed from the matrix resin for use in preparation of the polymer composition, with a measurement sample, and subjecting the film to an X-ray diffraction method. For example, measurement can be made according to the following method. First, the matrix resin is applied onto a substrate such as a glass substrate to produce a film M2 of the matrix resin. Next, the film M2 is subjected to measurement by an X-ray diffraction method.

In a case where any of the films M1 and M2 of the matrix resins is subjected to measurement by an X-ray diffraction method, scanning is made with the incident angle to the surface of such each film of the matrix resin being fixed to a minute angle (about 1° or less). Such scanning is preferably made along only the axis of a counter. Thus, the depth of X-ray penetration can be suppressed to the order of micrometers, thereby allowing for an enhancement in detection sensitivity of a signal from such each film of the matrix resin, with a signal of the substrate being suppressed.

For example, the degree of molecular packing in the matrix resin included in the polymer composition for a temperature-sensitive film can be measured according to a method described in “Examples” described below.

In a case where the degree of molecular packing in the matrix resin 103a constituting the temperature-sensitive film 103 or the matrix resin included in the polymer composition for a temperature-sensitive film is 40% or more, it can be said that the polymer chain in the matrix resin is sufficiently tightly aggregated. The polymer chain in the matrix resin is sufficiently tightly aggregated to thereby enable penetration of moisture into the temperature-sensitive film 103 to be effectively suppressed, resulting in an enhancement in stability of the electric resistance value of the temperature sensor element under a certain temperature environment.

Suppression of penetration of moisture into the temperature-sensitive film 103 can also contribute to suppression of deterioration in measurement accuracy as indicated in the following 1) and 2).

1) If moisture is diffused in the temperature-sensitive film 103, an ion channel with water tends to be formed to result in an increase in electric conductivity due to ion conduction or the like. Such an increase in electric conductivity due to ion conduction or the like can cause a thermistor-type temperature sensor element that detects the change in temperature, as the electric resistance value, to be deteriorated in measurement accuracy.

2) If moisture is diffused in the temperature-sensitive film 103, the matrix resin 103a tends to be swollen to result in an increase in distance between the conductive domains 103b. This can lead to an increase in electric resistance value detected by the temperature sensor element, resulting in deterioration in measurement accuracy.

It is considered that a degree of molecular packing in the matrix resin 103a constituting the temperature-sensitive film 103 or the matrix resin included in the polymer composition for a temperature-sensitive film, of 40% or more, can contribute to suppression of deterioration in measurement accuracy, resulting in an enhancement in stability of the electric resistance value of the temperature sensor element under a certain temperature environment.

Such molecular packing properties are based on intermolecular interaction. Accordingly, one solution to enhance molecular packing properties of the matrix resin is to introduce a functional group or moiety that easily results in intermolecular interaction, into a polymer chain.

Examples of the functional group or moiety include functional groups each capable of forming a hydrogen bond, such as a hydroxyl group, a carboxyl group, and an amino group, and functional groups or moieties (for example, moieties such as an aromatic ring) each capable of allowing π-π stacking interaction to occur.

In particular, in a case where a polymer capable of allowing π-π stacking interaction to occur is used in the matrix resin, packing due to π-π stacking interaction is easily uniformly extended to the entire molecule and thus penetration of moisture into the temperature-sensitive film 103 can be more effectively suppressed.

In a case where a polymer capable of allowing π-π, stacking interaction to occur is used in the matrix resin, a moiety allowing intermolecular interaction to occur is hydrophobic and thus penetration of moisture into the temperature-sensitive film 103 can be more effectively suppressed.

A crystalline resin and a liquid crystalline resin also each have a highly ordered structure, and thus are each suitable as a matrix resin 103a having a high degree of molecular packing.

However, an excessively high degree of molecular packing leads to a decrease in solvent solubility and makes it difficult to form the temperature-sensitive film. Additionally, the film is rigid and easily cracked, and is deteriorated in flexibility. Accordingly, the degree of molecular packing in the matrix resin is preferably 90% or less, more preferably 85% or less.

One resin preferably used as the matrix resin is a polyimide-based resin from the viewpoint of heat resistance of the temperature-sensitive film 103, film formability of the temperature-sensitive film 103, and the like. Such a polyimide-based resin preferably includes an aromatic ring and more preferably includes an aromatic ring in a main chain because π-π stacking interaction easily occurs.

The polyimide-based resin can be obtained by, for example, reacting a diamine and a tetracarboxylic acid, or reacting an acid chloride in addition to them. The diamine and the tetracarboxylic acid here also include respective derivatives. The “diamine” simply designated herein means any diamine and any derivative thereof, and the “tetracarboxylic acid” simply designated herein also means any derivative thereof again.

The diamine and the tetracarboxylic acid may be each used singly or in combinations of two or more kinds thereof.

Examples of the diamine include diamine and diaminodisilane, and preferably diamine.

Examples of the diamine include an aromatic diamine, an aliphatic diamine, or a mixture thereof, and preferably include an aromatic diamine. The aromatic diamine can be used to provide a polyimide-based resin where π-π stacking can be made.

The aromatic diamine refers to a diamine where an amino group is directly bound to an aromatic ring, and the structure thereof may partially include an aliphatic group, an alicyclic group or other substituent. The aliphatic diamine refers to a diamine where an amino group is directly bound to an aliphatic group or an alicyclic group, and the structure thereof may partially include an aromatic group or other substituent.

An aliphatic diamine having an aromatic group in a portion of the structure can also be used to provide a polyimide-based resin where π-π stacking can be made.

Examples of the aromatic diamine include phenylenediamine, diaminotoluene, diaminobiphenyl, bis(aminophenoxy)biphenyl, diaminonaphthalene, diaminodiphenyl ether, bis[(aminophenoxy)phenyl]ether, diaminodiphenyl sulfide, bis[(aminophenoxy)phenyl]sulfide, diaminodiphenyl sulfone, bis[(aminophenoxy)phenyl]sulfone, diaminobenzophenone, diaminodiphenylmethane, bis[(aminophenoxy)phenyl]methane, bisaminophenylpropane, bis[(aminophenoxy)phenyl]propane, bisaminophenoxybenzene, bis[(amino-α,α′-dimethylbenzyl)]benzene, bisaminophenyldiisopropylbenzene, bisaminophenylfluorene, bisaminophenylcyclopentane, bisaminophenylcyclohexane, bisaminophenylnorbornane, bisaminophenyladamantane, and such any compound where one or more hydrogen atoms of the compound are each replaced with a fluorine atom or a hydrocarbon group including a fluorine atom (trifluoromethyl group or the like).

The aromatic diamine may be used singly or in combinations of two or more kinds thereof.

Examples of the phenylenediamine include m-phenylenediamine and p-phenylenediamine.

Examples of the diaminotoluene include 2,4-diaminotoluene and 2,6-diaminotoluene.

Examples of the diaminobiphenyl include benzidine (another name: 4,4′-diaminobiphenyl), o-tolidine, m-tolidine, 3,3′-dihydroxy-4,4′-diaminobiphenyl, 2,2-bis(3-amino-4-hydroxyphenyl)propane (BAPA), 3,3′-dimethoxy-4,4′-diaminobiphenyl, 3,3′-dichloro-4,4′-diaminobiphenyl, 2,2′-dimethyl-4,4′-diaminobiphenyl, and 3,3′-dimethyl-4,4′-diaminobiphenyl.

Examples of the bis(aminophenoxy)biphenyl include 4,4′-bis(4-aminophenoxy)biphenyl (BAPB), 3,3′-bis(4-aminophenoxy)biphenyl, 3,4′-bis(3-aminophenoxy)biphenyl, 4,4′-bis(2-methyl-4-aminophenoxy)biphenyl, 4,4′-bis(2,6-dimethyl-4-aminophenoxy)biphenyl, and 4,4′-bis(3-aminophenoxy)biphenyl.

Examples of the diaminonaphthalene include 2,6-diaminonaphthalene and 1,5-diaminonaphthalene.

Examples of the diaminodiphenyl ether include 3,4′-diaminodiphenyl ether and 4,4′-diaminodiphenyl ether.

Examples of the bis[(aminophenoxy)phenyl]ether include bis[4-(3-aminophenoxy)phenyl]ether, bis[4-(4-aminophenoxy)phenyl]ether, bis[3-(3-aminophenoxy)phenyl]ether, bis(4-(2-methyl-4-aminophenoxy)phenyl)ether, and bis(4-(2,6-dimethyl-4-aminophenoxy)phenyl)ether.

Examples of the diaminodiphenyl sulfide include 3,3′-diaminodiphenyl sulfide, 3,4′-diaminodiphenyl sulfide, and 4,4′-diaminodiphenyl sulfide.

Examples of the bis[(aminophenoxy)phenyl]sulfide include bis[4-(4-aminophenoxy)phenyl]sulfide, bis[3-(4-aminophenoxy)phenyl]sulfide, bis[4-(3-aminophenoxy)phenyl]sulfide, bis[3-(4-aminophenoxy)phenyl]sulfide, and bis[3-(3-aminophenoxy)phenyl]sulfide.

Examples of the diaminodiphenyl sulfone include 3,3′-diaminodiphenyl sulfone, 3,4′-diaminodiphenyl sulfone, and 4,4′-diaminodiphenyl sulfone.

Examples of the bis[(aminophenoxy)phenyl]sulfone include bis[3-(4-aminophenoxy)phenyl]sulfone, bis[4-(4-aminophenyl)]sulfone, bis[3-(3-aminophenoxy)phenyl]sulfone, bis[4-(3-aminophenyl)]sulfone, bis[4-(4-aminophenoxy)phenyl]sulfone, bis[4-(2-methyl-4-aminophenoxy)phenyl]sulfone, and bis[4-(2,6-dimethyl-4-aminophenoxy)phenyl]sulfone.

Examples of the diaminobenzophenone include 3,3′-diaminobenzophenone and 4,4′-diaminobenzophenone.

Examples of the diaminodiphenylmethane include 3,3′-diaminodiphenylmethane, 3,4′-diaminodiphenylmethane, and 4,4′-diaminodiphenylmethane.

Examples of the bis[(aminophenoxy)phenyl]methane include bis[4-(3-aminophenoxy)phenyl]methane, bis[4-(4-aminophenoxy)phenyl]methane, bis[3-(3-aminophenoxy)phenyl]methane, and bis[3-(4-aminophenoxy)phenyl]methane.

Examples of the bisaminophenylpropane include 2,2-bis(4-aminophenyl)propane, 2,2-bis(3-aminophenyl)propane, 2-(3-aminophenyl)-2-(4-aminophenyl)propane, 2,2-bis(2-methyl-4-aminophenyl)propane, and 2,2-bis(2,6-dimethyl-4-aminophenyl)propane.

Examples of the bis[(aminophenoxy)phenyl]propane include 2,2-bis[4-(2-methyl-4-aminophenoxy)phenyl]propane, 2,2-bis[4-(2,6-dimethyl-4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]propane, and 2,2-bis[3-(4-aminophenoxy)phenyl]propane.

Examples of the bisaminophenoxybenzene include 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,4-bis(2-methyl-4-aminophenoxy)benzene, 1,4-bis(2,6-dimethyl-4-aminophenoxy)benzene, 1,3-bis(2-methyl-4-aminophenoxy)benzene, and 1,3-bis(2,6-dimethyl-4-aminophenoxy)benzene.

Examples of the bis(amino-α,α′-dimethylbenzyl)benzene (another name: bisaminophenyldiisopropylbenzene) include 1,4-bis(4-amino-α,α′-dimethylbenzyl)benzene (BiSAP, another name: α,α′-bis(4-aminophenyl)-1,4-diisopropylbenzene), 1,3-bis[4-(4-amino-6-methylphenoxy)-α,α′-dimethylbenzyl]benzene, α,α′-bis(2-methyl-4-aminophenyl)-1,4-diisopropylbenzene, α,α′-bis(2,6-dimethyl-4-aminophenyl)-1,4-diisopropylbenzene, α,α′-bis(3-aminophenyl)-1,4-diisopropylbenzene, α,α′-bis(4-aminophenyl)-1,3-diisopropylbenzene, α,α′-bis(2-methyl-4-aminophenyl)-1,3-diisopropylbenzene, α,α′-bis(2,6-dimethyl-4-aminophenyl)-1,3-diisopropylbenzene, and α,α′-bis(3-aminophenyl)-1,3-diisopropylbenzene.

Examples of the bisaminophenyl fluorene include 9,9-bis(4-aminophenyl)fluorene, 9,9-bis(2-methyl-4-aminophenyl)fluorene, and 9,9-bis(2,6-dimethyl-4-aminophenyl)fluorene.

Examples of the bisaminophenylcyclopentane include 1,1-bis(4-aminophenyl)cyclopentane, 1,1-bis(2-methyl-4-aminophenyl)cyclopentane, and 1,1-bis(2,6-dimethyl-4-aminophenyl)cyclopentane.

Examples of the bisaminophenylcyclohexane include 1,1-bis(4-aminophenyl)cyclohexane, 1,1-bis(2-methyl-4-aminophenyl)cyclohexane, 1,1-bis(2,6-dimethyl-4-aminophenyl)cyclohexane, and 1,1-bis(4-aminophenyl)4-methyl-cyclohexane.

Examples of the bisaminophenylnorbornane include 1,1-bis(4-aminophenyl)norbornane, 1,1-bis(2-methyl-4-aminophenyl)norbornane, and 1,1-bis(2,6-dimethyl-4-aminophenyl)norbornane.

Examples of the bisaminophenyladamantane include 1,1-bis(4-aminophenyl)adamantane, 1,1-bis(2-methyl-4-aminophenyl)adamantane, and 1,1-bis(2,6-dimethyl-4-aminophenyl)adamantane.

Examples of the aliphatic diamine include ethylenediamine, hexamethylenediamine, polyethylene glycol bis(3-aminopropyl)ether, polypropylene glycol bis(3-aminopropyl)ether, 1,3-bis(aminomethyl)cyclohexane, 1,4-bis(aminomethyl)cyclohexane, m-xylylenediamine, p-xylylenediamine, 1,4-bis(2-amino-isopropyl)benzene, 1,3-bis(2-amino-isopropyl)benzene, isophoronediamine, norbornanediamine, siloxanediamines, and such any compound where one or more hydrogen atoms of the compound are each replaced with a fluorine atom or a hydrocarbon group including a fluorine atom (trifluoromethyl group or the like).

The aliphatic diamine may be used singly or in combinations of two or more kinds thereof.

Examples of the tetracarboxylic acid include tetracarboxylic acid, tetracarboxylic acid esters, and tetracarboxylic dianhydride, and preferably include tetracarboxylic dianhydride.

Examples of the tetracarboxylic dianhydride include tetracarboxylic dianhydrides such as

pyromellitic dianhydride, 3,3′,4,4′-benzophenonetetracarboxylic dianhydride, 1,4-hydroquinonedibenzoate-3,3′,4,4′-tetracarboxylic dianhydride, 3,3′,4,4′-biphenyltetracarboxylic dianhydride, 3,3′,4,4′-diphenyl ether tetracarboxylic dianhydride (ODPA), 1,2,4,5-cyclohexanetetracarboxylic dianhydride (HPMDA), 1,2,3,4-cyclobutanetetracarboxylic dianhydride, 1,2,4,5-cyclopentanetetracarboxylic dianhydride, bicyclo[2,2,2]oct-7-ene-2,3,5,6-tetracarboxylic dianhydride, 2,3,3′,4′-biphenyltetracarboxylic dianhydride, 3,3′,4′-benzophenonetetracarboxylic dianhydride, 4,4-(p-phenylenedioxy)diphthalic dianhydride, and 4,4-(m-phenylenedioxy)diphthalic dianhydride;

2,2-bis(3,4-dicarboxyphenyl)propane, 2,2-bis(2,3-dicarboxyphenyl)propane, bis(3,4-dicarboxyphenyl)sulfone, bis(3,4-dicarboxyphenyl)ether, bis(2,3-dicarboxyphenyl)ether, 1,1-bis(2,3-dicarboxyphenyl)ethane, bis(2,3-dicarboxyphenyl)methane, and bis(3,4-dicarboxyphenyl)methane; and

such any compound where one or more hydrogen atoms of the compound are each replaced with a fluorine atom or a hydrocarbon group including a fluorine atom (trifluoromethyl group or the like).

The tetracarboxylic dianhydride may be used singly or in combinations of two or more kinds thereof.

Examples of the acid chloride include respective acid chlorides of a tetracarboxylic acid compound, a tricarboxylic acid compound, and a dicarboxylic acid compound, and in particular, an acid chloride of a dicarboxylic acid compound is preferably used. Examples of the acid chloride of a dicarboxylic acid compound include 4,4′-oxybis(benzoyl chloride) [OBBC] and terephthaloyl dichloride (TPC).

In a case where the matrix resin 103a includes a fluorine atom, penetration of moisture into the temperature-sensitive film 103 tends to be capable of being more effectively suppressed. A polyimide-based resin including a fluorine atom can be prepared by using one where at least any one of a diamine and a tetracarboxylic acid for use in preparation includes a fluorine atom.

One example of such a diamine including a fluorine atom is 2,2′-bis(trifluoromethyl)benzidine (TFMB). One example of such a tetracarboxylic acid including a fluorine atom is 4,4′-(1,1,1,3,3,3-hexafluoropropane-2,2-diyl)diphthalic dianhydride (6FDA).

The weight average molecular weight of the polyimide-based resin is preferably 20000 or more, more preferably 50000 or more, and preferably 1000000 or less, more preferably 500000 or less.

The weight average molecular weight can be determined with a size exclusion chromatography apparatus.

The matrix resin 103a preferably includes 50% by mass or more, more preferably 70% by mass or more, further preferably 90% by mass or more, still further preferably 95% by mass or more, particularly preferably 100% by mass of the polyimide-based resin, under the assumption that the total of the resin component(s) constituting the matrix resin corresponds to 100% by mass. The polyimide-based resin is preferably a polyimide-based resin including an aromatic ring, more preferably, a polyimide-based resin including an aromatic ring and a fluorine atom.

On the other hand, the matrix resin 103a preferably has the property of easily forming a film from the viewpoint of film formability. In one example thereof, the matrix resin 103a is preferably a soluble resin excellent in wet film formability. A resin structure imparting the property is, for example, one having a properly bent structure in a main chain, and such a structure is obtained by, for example, a method of bending the structure by allowing the main chain to contain an ether bond, or a method of bending the structure by steric hindrance by introducing a substituent such as an alkyl group into the main chain.

[3-3] Configuration of Temperature-Sensitive Film

The temperature-sensitive film 103 has a configuration that includes the matrix resin 103a and the plurality of conductive domains 103b contained in the matrix resin 103a. The plurality of conductive domains 103b are preferably dispersed in the matrix resin 103a. The conductive domains 103b preferably include a conductive polymer including a conjugated polymer and a dopant, and are more preferably constituted by a conductive polymer.

The total content of the conjugated polymer and the dopant in the temperature-sensitive film 103 is preferably 90% by mass or less, more preferably 80% by mass or less, further preferably 70% by mass or less, still further preferably 60% by mass or less based on 100% by mass of the total amount of the matrix resin 103a, the conjugated polymer and the dopant, from the viewpoint of effective suppression of penetration of moisture into the temperature-sensitive film 103. If the total content of the conjugated polymer and the dopant is more than 90% by mass, the content of the matrix resin 103a in the temperature-sensitive film 103 is low, resulting in a tendency to deteriorate the effect of suppressing penetration of moisture into the temperature-sensitive film 103.

The total content of the conjugated polymer and the dopant in the temperature-sensitive film 103 is preferably 5% by mass or more, more preferably 10% by mass or more, further preferably 20% by mass or more, still further preferably 30% by mass or more based on 100% by mass of the total amount of the matrix resin 103a, the conjugated polymer and the dopant, from the viewpoint of a reduction in power consumption of the temperature sensor element and from the viewpoint of a normal operation of the temperature sensor element.

A low total content of the conjugated polymer and the dopant results in a tendency to increase the electric resistance, sometimes leading to an increase in current necessary for measurement and thus a remarkably increase in power consumption. A low total content of the conjugated polymer and the dopant also sometimes provides no communication between the electrodes. A low total content of the conjugated polymer and the dopant sometimes causes Joule heat to be generated depending on the current flowing, and also sometimes makes temperature measurement by itself difficult. Accordingly, the total content of the conjugated polymer and the dopant, which enables the conductive polymer to be formed, is preferably in the above range.

The thickness of the temperature-sensitive film 103 is not particularly limited, and is, for example, 0.3 μm or more and 50 μm or less. The thickness of the temperature-sensitive film 103 is preferably 0.3 μm or more and 40 μm or less from the viewpoint of flexibility of the temperature sensor element.

[3-4] Production of Temperature-Sensitive Film

In a case where the conductive domains 103b include a conductive polymer, the temperature-sensitive film 103 is obtained by stirring and mixing the conjugated polymer, the dopant, the matrix resin (for example, thermoplastic resin), and a solvent to thereby, prepare a polymer composition for a temperature-sensitive film, and forming the composition into a film. Examples of the film formation method include a method involving applying the polymer composition for a temperature-sensitive film onto the substrate 104, and then drying and, if necessary, heat-treating the resultant. The method of applying the polymer composition for a temperature-sensitive film is not particularly limited, and examples include a spin coating method, a screen printing method, an ink-jet printing method, a dip coating method, an air knife coating method, a roll coating method, a gravure coating method, a blade coating method, and a dropping method.

In a case where the matrix resin 103a is formed from an active energy ray-curable resin or a thermosetting resin, a curing treatment is further applied. In a case where an active energy ray-curable resin or a thermosetting resin is used, no solvent may be required to be added to the polymer composition for a temperature-sensitive film, and in this case, no drying treatment is also required.

in a case where the conductive domains 103b are formed by a conductive polymer, the conjugated polymer and the dopant usually form a conductive polymer particle (conductive particle) in the polymer composition for a temperature-sensitive film, and the particle is dispersed in the composition. Herein, such any particle for forming the conductive domains 103b, for example, the conductive polymer, present in the polymer composition for a temperature-sensitive film is also referred to as “conductive particle”. Such each conductive particle in the polymer composition for a temperature-sensitive film forms the conductive domains 103b in the temperature-sensitive film 103.

The content of the matrix resin in the polymer composition (excluding the solvent) for a temperature-sensitive film is substantially the same as the content of the matrix resin in the temperature-sensitive film 103 formed from the composition. Much the same is true on a case where the conductive domains 103b are formed by a material other than the conductive polymer.

The content of each component included in the polymer composition for a temperature-sensitive film corresponds to the content of each component relative to the total of each component in the polymer composition for a temperature-sensitive film, excluding the solvent, and is preferably substantially the same as the content of each component in the temperature-sensitive film 103 formed from the polymer composition for a temperature-sensitive film.

In a case where the conductive domains 103b are formed by the conductive polymer, the solvent included in the polymer composition for a temperature-sensitive film is preferably a solvent that can dissolve the conjugated polymer, the dopant and the matrix resin, from the viewpoint of film formability.

The solvent is preferably selected depending on, for example, the solubilities in the conjugated polymer, the dopant and the matrix resin used.

Examples of such a usable solvent include N-methyl-2-pyrrolidone, N,N-dimethylacetamide, N,N-diethylacetamide, N,N-dimethylformamide, N,N-diethylformamide, N-methylcaprolactam, N-methylformamide, N,N,2-trimethylpropionamide, hexamethylphosphoramide, tetramethylenesulfone, dimethylsulfoxide, m-cresol, phenol, p-chlorophenol, 2-chloro-4-hydroxytoluene, diglyme, triglyme, tetraglyme, dioxane, γ-butyrolactone, dioxolane, cyclohexanone, cyclopentanone, 1,4-dioxane, ε-caprolactam, dichloromethane, and chloroform.

The solvent may be used singly or in combinations of two or more kinds thereof.

The polymer composition for a temperature-sensitive film may include one or more additives such as an antioxidant, a flame retardant, a plasticizer, and an ultraviolet absorber.

In a case where the conductive domains 103b are formed by the conductive polymer, the total content of the conjugated polymer, the dopant and the matrix resin in the polymer composition for a temperature-sensitive film is preferably 90% by mass or more under the assumption that the solid content (all components other than the solvent) of the polymer composition for a temperature-sensitive film is 100% by mass. The total content is more preferably 95% by mass or more, further preferably 98% by mass or more, and may be 100% by mass.

[4] Temperature Sensor Element

The temperature sensor element can include any constituent component other than the above constituent components. Examples of such other constituent component include those commonly used for temperature sensor elements, such as an electrode, an insulation layer, and a sealing layer that seals the temperature-sensitive film.

The temperature sensor element including the temperature-sensitive film is hardly varied in electric resistance value detected, when placed under an environment at a certain temperature, and can more reliably measure the temperature than a conventional temperature sensor element. This can be evaluated by leaving the temperature sensor element to still stand under a certain temperature environment and measuring the variation in electric resistance value during the time for such still standing, and can be evaluated according to, for example, the following method.

First, the pair of electrodes of the temperature sensor element and a commercially available digital multimeter are connected with a lead wire, and the temperature of the temperature sensor element is adjusted to a predetermined temperature by use of a commercially available Peltier temperature controller. The electric resistance value R1 after a lapse of a certain time from the adjustment of the temperature of the temperature sensor element to a predetermined temperature, and the electric resistance value R2 after a lapse of an additional certain time are measured. The electric resistance values R1 and R2 are each preferably measured at two points in the temperature range in which the temperature sensor can be used. In Examples described below, the temperature sensor element is adjusted to each temperature of 20° C. or 50° C., and the electric resistance value R1 is measured after 5 minutes of the adjustment and the electric resistance value R2 is measured after 60 minutes of the adjustment.

The electric resistance values measured as above are plugged in the following expression, and the rate of change r (%) in electric resistance value can be determined.

r (%)=100×(|R1−R2|/R1)

A smaller numerical value of the rate of change r (%) means that the electric resistance value detected by the temperature sensor element is less varied when placed under an environment at a certain temperature. The temperature sensor element detects such each electric resistance value as the change in temperature, and thus the temperature sensor element can more reliably measure the temperature with a small change in temperature observed under an environment at a certain temperature.

The rate of change r (%) is preferably 1% or less, more preferably 0.95% or less, further preferably 0.9% or less. The rate of change r (%) is more preferably closer to 0%. The rate of change r (%) is preferably in the above range of the rate of change at each temperature at two or more points. The rate of change is preferably in the above range at each temperature at two or more points because the temperature tends to be capable of being more reliably measured in the temperature range in which the temperature sensor is applied.

### EXAMPLES

Hereinafter the present invention is further specifically described with reference to Examples, but the present invention is not limited to these Examples at all. In Examples, “%” and “part(s)” representing any content or amount of use are on a mass basis, unless particularly noted.

### Production Example 1

### Preparation of Dedoped Polyaniline

A dedoped polyaniline was prepared by preparing and dedoping a polyaniline doped with hydrochloric acid, as shown in the following [1] and [2].

[1] Preparation of Polyaniline Doped with Hydrochloric Acid

A first aqueous solution was prepared by dissolving 5.18 g of aniline hydrochloride (manufactured by Kanto Kagaku) in 50 mL of water. A second aqueous solution was prepared by dissolving 11.42 g of ammonium persulfate (manufactured by Fujifilm Wako Pure Chemical Corporation) in 50 mL of water.

Next, the first aqueous solution was stirred using a magnetic stirrer at 400 rpm for 10 minutes with the temperature being regulated at 35° C., and thereafter, the second aqueous solution was dropped to the first aqueous solution at a dropping speed of 5.3 mL/min under stirring at the same temperature. After the dropping, a reaction was further allowed to occur for 5 hours with a reaction liquid being kept at 35° C., and thus a solid was precipitated in the reaction liquid.

Thereafter, the reaction liquid was filtered by suction with a paper filter (second kind for chemical analysis in JIS P 3801), and the resulting solid was washed with 200 mL of water. Thereafter, the solid was washed with 100 mL of 0.2 M hydrochloric acid and then 200 mL of acetone, and thereafter dried in a vacuum oven, thereby obtaining a polyaniline doped with hydrochloric acid, represented by the following formula (1).

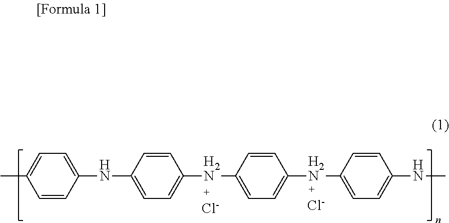

[2] Preparation of Dedoped Polyaniline

Four g of the polyaniline doped with hydrochloric acid, obtained in [1], was dispersed in 100 mL of 12.5% by mass ammonia water and the resultant was stirred with a magnetic stirrer for about 10 hours, thereby precipitating a solid in a reaction liquid.

Thereafter, the reaction liquid was filtered by suction with. a paper filter (second kind for chemical analysis in JIS P 3801), and the resulting solid was washed with 200 mL of water and then 200 mL of acetone. Thereafter, the solid was dried in vacuum at 50° C., thereby obtaining a dedoped polyaniline represented by the following formula (2). The dedoped polyaniline was dissolved in N-methylpyrrolidone (NMP; Tokyo Chemical Industry Co., Ltd.) so that the concentration was 5% by mass, thereby preparing a solution of the dedoped polyaniline (conjugated polymer).

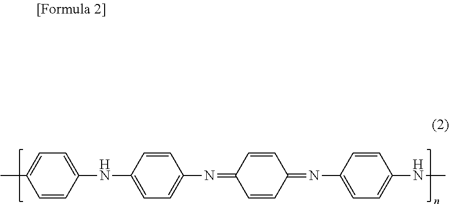

### Production Example 2

### Preparation of Matrix Resin 1

A powder of polyimide having a repeating unit represented by the following formula (5) was produced using 2,2′-bis(trifluoromethyl)benzidine (TFMB) represented by the following formula (3), as a diamine, and 4,4′-(1,1,1,3,3,3-hexafluoropropane-2,2-diyl)diphthalic dianhydride (6FDA) represented by the following formula (4), as a tetracarboxylic dianhydride, according to the description in Example 1 of International Publication No. WO 2017/179367.

The powder was dissolved is propylene glycol 1-monomethyl ether 2-acetate so that the concentration was 8% by mass, thereby preparing polyimide solution (1). In the following Examples, polyimide solution (1) was used as matrix resin 1.

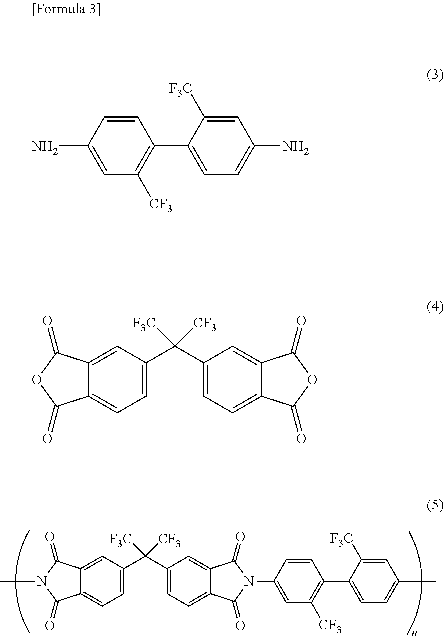

### Production Example 3

### Preparation of Matrix Resin 2

Fifty two g (162.38 mmol) of TFMB represented by the formula (3) and 884.53 g of dimethylacetamide (DMAc) were added to a 1-L separable flask equipped with a stirring blade, and TFMB was dissolved in DMAc at room temperature under stirring, under a nitrogen gas atmosphere, according to Example 5 of Japanese Patent Laid-Open No. 2018-119132.

Next, 17.22 g (38.79 mmol) of 6FDA represented by the formula (4) was added to the flask, and stirred at room temperature for 3 hours.

Thereafter, 4.80 g (16.26 mmol) of 4,4′-oxybis(benzoyl chloride) [OBBC] represented by the following formula (6) and then 19.81 g (97.57 mmol) of terephthaloyl dichloride (TPC) were added to the flask, and stirred at room temperature for 1 hour.

Next, 8.73 g (110.42 mmol) of pyridine and 19.92 g (195.15 mmol) of acetic anhydride were added to the flask, stirred at room temperature for 30 minutes, then heated to 70° C. by use of an oil bath, and further stirred for 3 hours, thereby obtaining a reaction liquid.

The resulting reaction liquid was cooled to room temperature and loaded in a thin stream, into a large amount of methanol, and a product precipitated was taken out and immersed in methanol for 6 hours, and thereafter washed with methanol.

Next, the product precipitated was dried under reduced pressure at 100° C., thereby obtaining a polyimide powder.

The powder was dissolved in γ-butyrolactone so that the concentration was 8% by mass, thereby preparing polyimide solution (2). In the following Examples, polyimide solution (2) was used as matrix resin 2.

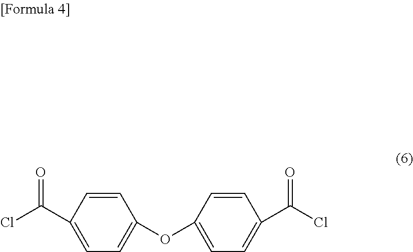 [SMILES: O=C(Cl)c1ccc(Oc2ccc(C(=O)Cl)cc2)cc1]

### Production Example 4

### Preparation of Matrix Resin 3

4,4′-Bis(4-aminophenoxy)biphenyl (BAPB) represented by the following formula (7) and 1,4-bis(4-amino-α,α-dimethylbenzyl)benzene (BiSAP) represented by the following formula (8), as diamines, and 1,2,4,5-cyclohexanetetracarboxylic dianhydride (HPMDA) represented by the following formula (9), as a tetracarboxylic dianhydride, were used. A polyimide solution was obtained according to the description in Synthesis Example 2 of Japanese Patent Laid-Open No. 2016-186004 except that the molar ratio of BAPB:BiSAP:HPMDA was 0.5:0.5:1, and a polyimide powder was obtained according to the description in Example 2 of the Publication.

The powder was dissolved in γ-butyrolactone so that the concentration was 8% by mass, thereby preparing polyimide solution (3). In the following Examples, polyimide solution (3) was used as matrix resin 3.

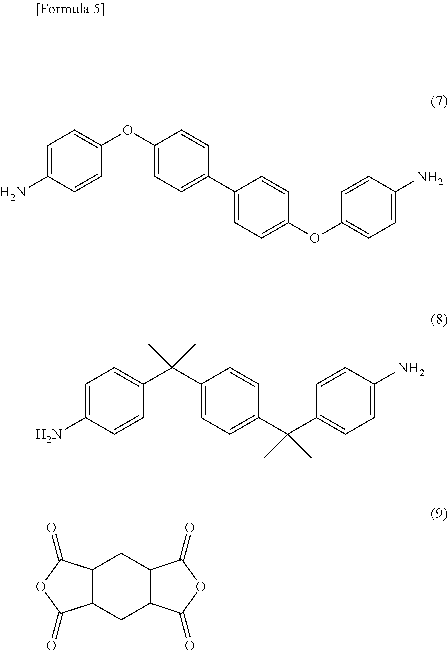 [SMILES: Nc1ccc(Oc2ccc(-c3ccc(Oc4ccc(N)cc4)cc3)cc2)cc1 ; CC(C)(c1ccc(N)cc1)c1ccc(C(C)(C)c2ccc(N)cc2)cc1 ; O=C1OC(=O)C2CC3C(=O)OC(=O)C3CC12]

### Production Example 5

### Preparation of Matrix Resin 4

Polyvinyl alcohol (manufactured by Sigma-Aldrich Co. LLC, weight average molecular weight: 89000 to 90000) was dissolved is distilled water so that the concentration was 8% by mass, thereby preparing polyvinyl alcohol solution (1). In the following Examples, polyvinyl alcohol solution (1) was used as matrix resin 4.

### Production Example 6

### Preparation of Matrix Resin 5

Polyacrylic acid (manufactured by Fujifilm Wako Pure Chemical Corporation, weight average molecular weight: 25000) was dissolved in distilled water so that the concentration was 8% by mass, thereby preparing polyacrylic acid solution (1). In the following Examples, polyacrylic acid solution (1) was used as matrix resin 5.

### Production Example 7

### Preparation of Matrix Resin 6

Polystyrene (manufactured by Sigma-Aldrich Co. LLC, weight average molecular weight: about 350000, number average molecular weight: about 170000) was dissolved in toluene so that the concentration was 8% by mass, thereby preparing polystyrene solution (1). In the following Examples, polystyrene solution (1) was used as matrix resin 6.

### Example 1

[1] Preparation of Polymer Composition for Temperature-Sensitive Film

A polymer composition for a temperature-sensitive film was prepared by mixing 0.500 g of a solution of the dedoped polyaniline prepared in Production Example 1, 0.920 g of NMP (Tokyo Chemical Industry Co., Ltd.), 0.730 g of polyimide solution (1) as matrix resin 1, and 0.026 g of (+)-camphorsulfonic acid (Tokyo Chemical Industry Co., Ltd.) as a dopant.

[2] Production of Temperature Sensor Element

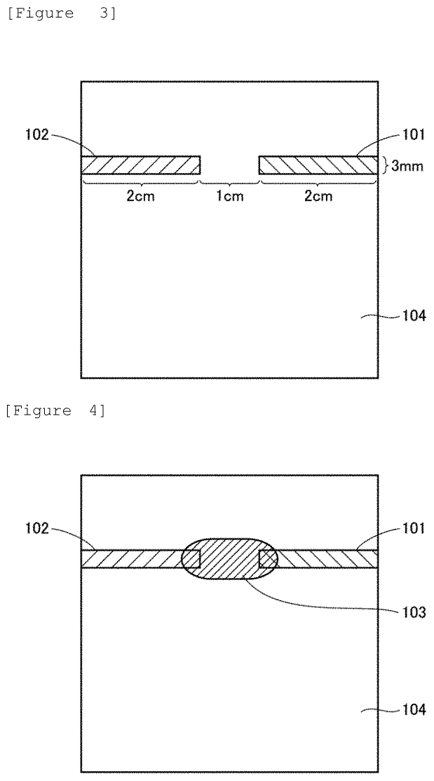

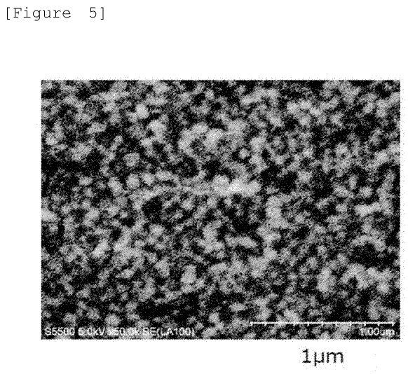

The production procedure of a temperature sensor element is described with reference to FIG. 3 and FIG. 4.

A pair of rectangular Au electrodes of 2 cm is length×3 mm in width was formed on one surface of a glass substrate (“Eagle XG” manufactured by Corning Incorporated) of a 5-cm square by sputtering using Ioncoater (“IB-3” manufactured by Eiko Corporation), with reference to FIG. 3.

The thickness of each of the Au electrodes according to cross section observation with a scanning electron microscope (SEM) was 200 nm.

Next, 200 μL of the polymer composition for a temperature-sensitive film, prepared in [1], was dropped between the pair of Au electrodes formed on the glass substrate, with reference to FIG. 4. A film of the polymer composition for a temperature-sensitive film, formed by the dropping, was in contact with both the electrodes. Thereafter, the film was subjected to a drying treatment at 50° C. under normal pressure for 2 hours and then at 50° C. under vacuum for 2 hours, and thereafter a heat treatment at 100° C. for about 1 hour, thereby forming a temperature-sensitive film and producing a temperature sensor element. The thickness of the temperature-sensitive film was measured with Dektak KXT (manufactured by Bruker), and was 30 μm.

### Example 2

A polymer composition for a temperature-sensitive film was prepared in the same manner as in Example 1 except that polyimide solution (1) of Example 1 was changed to polyimide solution (2) as matrix resin 2. A temperature-sensitive film was formed and a temperature sensor element was produced using the polymer composition for a temperature-sensitive film in the same manner as Example 1. The thickness of the temperature-sensitive film was measured in the same manner as in Example 1, and was 30 μm.

### Example 3

A polymer composition for a temperature-sensitive film was prepared in the same manner as in Example 1 except that polyimide solution (1) of Example 1 was changed to polyimide solution (3) as matrix resin 3. A temperature-sensitive film was formed and a temperature sensor element was produced using the polymer composition for a temperature-sensitive film in the same manner as in Example 1. The thickness of the temperature-sensitive film was measured in the same manner as in Example 1, and was 30 μm.

### Comparative Example 1

A polymer composition for a temperature-sensitive film was prepared in the same manner as in Example 1 except that polyimide solution (1) of Example 1 was changed to polyvinyl alcohol solution (1) as matrix resin 4. A temperature-sensitive film was formed and a temperature sensor element was produced using the polymer composition for a temperature-sensitive film in the same manner as in Example 1. The thickness of the temperature-sensitive film was measured in the same manner as in Example 1, and was 30 μm.

### Comparative Example 2

A polymer composition for a temperature-sensitive film was prepared in the same manner as in Example 1 except that polyimide solution (1) of Example 1 was changed to polyacrylic acid solution (1) as matrix resin 5. A temperature-sensitive film was formed and a temperature sensor element was produced using the polymer composition for a temperature-sensitive film in the same manner as in Example 1. The thickness of the temperature-sensitive film was measured in the same manner as in Example 1, and was 30 μm.

### Comparative Example 3

A polymer composition for a temperature-sensitive film was prepared in the same manner as in Example 1 except that polyimide solution (1) of Example 1 was changed to polystyrene solution (1) as matrix resin 6. A temperature-sensitive film was formed and a temperature sensor element was produced using the polymer composition for a temperature-sensitive film in the same manner as Example 1. The thickness of the temperature-sensitive film was measured in the same manner as in Example 1, and was 30 μm.

The content rate of the matrix resin in 100% by mass of the total amount of the polyaniline as the conjugated polymer and the matrix resin in each of the polymer compositions for a temperature-sensitive film, prepared in Examples 1 to 3 and Comparative Examples 1 to 3, was 53.6% by mass.

FIG. 5 illustrates a SEM photograph imaging a cross section of the temperature-sensitive film in the temperature sensor element produced in Example 2. A white-photographed portion corresponded to conductive domains dispersed in the matrix resin.

[Measurement of Degree of Molecular Packing in Matrix Resin]

The degree of molecular packing in the matrix resin was measured by performing the following operation with respect to respective solutions including matrix resins 1 to 6 prepared in Production Examples 2 to 7. First, a solution including such each matrix resin was applied onto one surface of a glass substrate, by spin coating. Thereafter, the resultant was subjected to a drying treatment at 50° C. under normal pressure for 2 hours and then at 50° C. under vacuum for 2 hours, and thereafter a heat treatment at 100° C. for about 1 hour, thereby forming a film of such each matrix resin. The thickness of the film of such each matrix resin was 10 μm.

The resulting film of such each. matrix resin was subjected to X-ray profile measurement with an X-ray diffraction apparatus. Measurement conditions were as follows.

X-Ray Diffraction Apparatus: “Smart Lab” Manufactured by Rigaku Corporation

X-ray source: CuKα

Incident angle (ω) of X-ray: fixed at 0.2°

Output: 9 kW (45 kV-200 mA)

Measurement range: 2θ=0° to 40°

Step: 0.04°

Scanning rate: 2θ=4°/min

Slit: Soller/PSC=5°, IS in length=15 mm, PSA=0.5 deg, RS=Open, IS=0.2 mm

The resulting X-ray profile was subjected to fitting with the Gaussian function by use of free software (Fityk), and a peak derived from an ordered structure and a peak derived from an amorphous structure were separated. The assignment of each of the peaks separated, with respect to each of the matrix resins, is shown below.

<Matrix Resins 1 to 3>

Peak Derived from Ordered Structure

2θ=13.2, packing of molecular chain in in-plane direction.

2θ=16.3, layer structure in out-plane direction

2θ=23.7, π-π stacking in benzene ring

Peak Derived from Amorphous Structure

2θ=19.4, amorphous

<Matrix Resin 4>

Peak Derived from an Ordered Structure

2θ=10.8, (1 0 0) plane

2θ=19.4, (1 0 1−) plane

2θ=20.0, (1 0 1) plane

2θ=22.9, (2 0 0) plane

Peak Derived from an Amorphous Structure

2θ=20.1, amorphous

<Matrix Resin 5>

No peak derived from an ordered structure was observed_{—}

<Matrix Resin 6>

No peak derived from an ordered structure was observed.

The degree of molecular packing in the matrix resin was determined based on the results of peak separation in the X-ray profile, according to the following expression (I). The results are shown in Table 1.

Degree of molecular packing (%)=100×(Area of peak derived from ordered structure)/(Total area of all peaks) (I)

A peak derived from an ordered structure refers to a peak having a half-value width of 10° or less. All peaks mean a peak derived from as ordered structure and a peak derived from an amorphous structure. Such a peak derived from an amorphous structure refers to a peak having a half-value width of more than 10°.

[Evaluation of Temperature Sensor Element]

The stability of the electric resistance value exhibited by the temperature sensor element placed under an environment at normal humidity (about 30% RH) and a certain. temperature was evaluated. Specifically, the evaluation was performed as follows.

The pair of Au electrodes in the temperature sensor element and a digital multimeter (“B35T+” manufactured by OWON Japan) were connected with a lead wire. The temperature of the temperature sensor element was adjusted to 20° C. by use of a Peltier temperature controller (“HMC-10F-0100” manufactured by Hayashi-Repic Co., Ltd.). The electric resistance value R5 after 5 minutes and the electric resistance value R60 after 60 minutes, from the adjustment of the temperature of the temperature sensor element to 20° C., were measured, and the rate of change r (%) in electric resistance value was determined according to the following expression. The results are shown in Table 1.

r (%)=100×(|R5−R60|/R5)

A lower rate of change r (%) means that the electric resistance value detected by the temperature sensor element is more hardly varied when the temperature sensor element is placed under an environment at a certain temperature.

The rate of change r (%) was also determined in the same manner as described above except that the temperature of the temperature sensor element was adjusted. to 50° C. The results are shown together in Table 1.

TABLE 1

| | Matrix resin | | Rate of change r (%) in | |
|---|---|---|---|---|
| | | Degree of | electric resistance value | |
| | | molecular | Temperature | Temperature |
| | No. | packing (%) | 20° C. | 50° C. |
| Example 1 | 1 | 68.9 | 0.39 | 0.89 |
| Example 2 | 2 | 67.9 | 0.44 | 0.77 |
| Example 3 | 3 | 43.6 | 0.42 | 0.45 |
| Comparative | 4 | 37.6 | 99.08 | 1.05 |
| Example 1 | | | | |
| Comparative | 5 | 0 | 0.59 | 3.83 |
| Example 2 | | | | |
| Comparative | 6 | 0 | 1.35 | 2.24 |
| Example 3 | | | | |

### REFERENCE SIGNS LIST

100 temperature sensor element, 101 first electrode, 102 second electrode, 103 temperature-sensitive film, 103a matrix resin, 103b conductive domain, 104 substrate.

1. A temperature sensor element comprising a pair of electrodes and a temperature-sensitive film disposed in contact with the pair of electrodes, wherein
the temperature-sensitive film comprises a matrix resin and a plurality of conductive domains contained in the matrix resin, and
the matrix resin constituting the temperature-sensitive film has a degree of molecular packing of 40% or more, as determined based on measurement by an X-ray diffraction method, according to the following expression (I):
Degree of molecular packing (%)=100×(Area of peak derived from ordered structure)/(Total area of all peaks) (I).

2. The temperature sensor element according to claim 1, wherein the conductive domains comprise a conductive polymer.

3. A temperature sensor element comprising a pair of electrodes and a temperature-sensitive film disposed in contact with the pair of electrodes, wherein
the temperature-sensitive film is formed from a polymer composition comprising a matrix resin having a degree of molecular packing of 40% or more, as determined based on measurement by an X-ray diffraction method, according to the following expression (I), and a conductive particle:
Degree of molecular packing (%)=100×(Area of peak derived from ordered structure)/(Total area of all peaks) (I).

4. The temperature sensor element according to claim 3, wherein the conductive particle comprises a conductive polymer.

5. The temperature sensor element according to claim 1, wherein the matrix resin comprises a polyimide-based resin.

6. The temperature sensor element according to claim 5, wherein the polyimide-based resin comprises an aromatic ring.
